(19) United States
(12) Patent Application Publication
(10) Pub. No.: US 2011/0124115 A1
(43) Pub. Date: May 26, 2011

(54) Indication enhanced colorimetric detector

(75) Inventor: Samuel David Piper, Carmichael, CA (US)

(73) Assignee: Piper Medical Inc, Carmichael, CA (US)

(21) Appl. No.: 12/927,749

(22) Filed: Nov. 22, 2010

Related U.S. Application Data
(60) Provisional application No. 61/283,024, filed on Nov. 24, 2009.

(51) Int. Cl. G01N 21/75

(52) U.S. Cl. 436/164; 422/420

(57) ABSTRACT

The present invention pertains generally to colorimetric indicia provided by a primary device, and more particularly, to at least one indicator moiety influenced by changing environments wherein the indicator moiety exhibits a rapid initial response and a protracted transient time for visualization by an operator. As compared to heretofore colorimetric indicator technologies, the present invention allows for improved accuracy of data interpretation by direct visual capture of changing environments with shorter duration transients.

### CROSS-REFERENCE TO RELATED APPLICATIONS

This application claims the benefit under 35 U.S.C. 119(e) of U.S. provisional application Ser. No. 61/283,024 filed Nov. 24, 2009, which is incorporated by reference herein in its entirety

### STATEMENT REGARDING FEDERALLY SPONSORED RESEARCH

Not Applicable

### BACKGROUND OF THE INVENTION

The ready detection of constituents of a gaseous environment is desirable wherein such detection indicates potential changes of the environment over time. Changes in a gaseous environment may indicate a variation is system or process either upstream (gaseous components feeding into the point of testing), results that might occur or be obtained downstream (wherein the gaseous environment is feeding into a system or process), and the combinations thereof. Where the detected gaseous constituents are of a critical nature in presenting effectiveness of an upstream process or to the effectiveness of a downstream process, should the detected value indicating the quantity or quality of that gaseous component or components be outside a particular desired range or threshold, a secondary condition may be triggered. Exemplary secondary conditions include means by which an operator is alerted of the deviation outside the specified range and initiation of control means by which the gaseous constituent is directly altered.

The use of detection/response process for gaseous environment assaying is particularly valuable to those in the agricultural, chemical manufacture, mining, fire-fighting, and medical fields. In agricultural applications, routine sampling of ethylene oxide is critical in maintaining and achieving optimal produce quality when shipped over long distances, and as such, a device which can readily sample storage environment of fresh produce and advise as to ethylene oxide in the gaseous environment is extremely beneficial. Chemical manufacturing often involves the introduction of one or more gaseous elements or compounds into a reaction chamber so as to produced a desired compound and/or the products or byproducts of such a compound formation process can be tracked to determine yield and quality. Safety concerns with regard to gaseous environments, particular wherein constituents of the gaseous environment are toxic or flammable, are a routine factor is the safe operation of mines and for fire-fighters entering an environment where the atmosphere may be unstable. A detection/response process for gaseous sampling is particularly advantageous when dealing with respiring organisms, and as such, use of a detector to determine inspiratory and/or expiratory conditions of a patient is particularly advantageous in the medical arts.

There are numerous means by which constituents of a gaseous environment can be determined, as evidenced by the plethora of technologies and devices presented in the prior art, including electrical sensors and liquid reagent reactions vessels. While electrical sensors which act directly upon a sample of a simple gaseous environment (i.e. limited differing constituents) have the capability to be sensitive and quite accurate, contamination of the sensors themselves often preclude the re-use of that sensor for assaying a second environment. Further, it is known in the art that electrical sensors begin to lose sensitivity when the gaseous test environment become increasingly complex as the colorimetric reactants begin to overlap with other gaseous constituents in the sample. Reiated to one-time use electrical sensors are bubble-jar mechanisms wherein a gaseous sample is presented into a reservoir of liquid colorimetric reagent. As the gas sample is buoyantly conveyed through the liquid reservoir, the reagent chemistry within the liquid interacts with the constituents of the gaseous sample, and a perceptible change is rendered. A particular disadvantage to the use of bubble-jars, beyond the limitation of single-time usage, is the fact that real-time results are difficult to achieve due to titration effects, sample dilution and stability such reagent chemistries have over time. Significant strides in gaseous environmental assaying with the introduction of indicator media and incorporation of such media into single-use, disposable carriers or housings.

Indicator devices such as those taught in: U.S. Pat. No. 6,187,596 to Dallas et al.; U.S. Pat. No. 6,378,522 to Pagan; U.S. Pat. No. 6,502,573 to Ratner; and, U.S. Pat. No. 7,578,971 to Ratner et al., each of which is included by reference in their respective entireties herein, are examples of single-use, disposable indicator assemblies wherein a colorimetric change is made visible to an operator when a particular gaseous constituent is present in a sample. These indicator devices can employ indicator media formed by various means, including indicator chemistries formed on or in porous substrates, such as taught in U.S. Pat. No. 5,005,572 to Raemer et al., and as reactive films, such as taught in U.S. Pat. No. 3,754,867 to Guenther, both of which are included by reference in their respective entireties.

Use of indicator devices relying on user perception of performance, while providing ready binary responses as the indicator media responds to gaseous constituents, suffer from a number of intrinsic and extrinsic failings. The colorimetric changes presented by the indicator media must be perceived by the operator to determine assay results. This requirement for perception of the actual indicator places a demand on the operator to be diligent in their efforts to routinely view the indicator for a protracted period of time, despite any environmental distractions that might occur, such as a medical practioner triaging a patient in an emergency room or a fire-fighter exiting a burning building. Hereforeto, indicator media colorimetric changes have been highly subjective and further complicate interpretation by transient conditions in the gaseous environment and contradictory performance responses to real-time changes of the environment within a useful time period. Specifically, prior art colorimetric indicators have been designed to respond rapidly to a fluidic trigger, with an undesirable and inherent attribute that the indicator has a low transient time in which the color can then be perceived by the operator (i.e. fast response/fast fade).

A particular application of interest wherein transient gaseous environments are assayed for presence and quantity of constituents is the field of carbon dioxide indicators for medical respiratory devices. Carbon dioxide indicators are utilized to determine the end tidal carbon dioxide concentration in expiratory gas from a patient, wherein deviation outside of norms is indicative of a potentially emergent respiration issue. In a related application, carbon dioxide indicators can be employed in conjunction with an endotracheal tube during intubation. In the event that the endotracheal tube is incorrectly placed in a non-respiratory associated conduit (i.e. the esophagus), there will be minimal to no carbon dioxide cycled from the patient as presented by failure of the carbon dioxide indicator to present a significant color change, and the patient will have to be re-intubated. Again, timely response of a carbon dioxide indicator is constrained by the same operational limitations elucidated above, with the additional issues of an emergent situation demanding additional attention to the device by harried emergency medical providers, emergency medical providers which may have to be simultaneously performing life-saving procedures. It should be noted that simply increasing the size of a carbon dioxide indicator to have a larger viewable window is contraindicated by the requirement such increase in size would have on significantly magnifying the volume constrained within the device itself. A larger volume results in a higher percentage of expiratory gases that are captured and re-breathed by the patient, with a deleterious effect of diminishing the ability to oxygenate the patient effectively and skewing of the carbon dioxide indicator itself by the trapped volume. A further problem exists with patients that have high respiratory rates approaching 100 breaths per minute or more. Such high breathing rates are not uncommon among the pediatric and neonate patient population. Although existing colorimetric disposable devices meet many of the needs for slower respiratory rates, they lack the ability to provide a visibly distinguishing signal that is detectable to the clinician at higher respiratory rates (i.e. clinicians are not able to tell if there is a color change with each inhalation and exhalation at high respiratory rates).

There remains an unmet need for a method and means for visually detecting colorimetric changes in associated disposable indicator assemblies and rendering an accurate objective result there from in real-time, and there is a further need for a method and means for visually detecting colorimetric changes in associated disposable indicator assemblies and rendering an accurate objective result there from in real-time for high respiratory rates.

### SUMMARY OF THE INVENTION

The present invention pertains generally to colorimetric indicia provided by a primary device, and more particularly, to at least one indicator moiety influenced by changing environments wherein an enhanced transient time colorimetric indicator exhibits a rapid initial response to a trigger condition and a protracted transient time for improved visual data capture by an operator. Unlike prior art colorimetric technologies wherein a desirable rapid positive response to exposure to a gaseous component results in a corresponding rapid and undesirable contrary response when the trigger condition is removed (i.e. changing of gaseous component concentration away from the trigger point), the present invention allows for an initial rapid response followed by a protracted transient time wherein the colorimetric change is maintained for an extended period.

In a preferred embodiment, a detection sensor assembly is adapted to measure at least one indicator moiety influenced by changing environments, wherein the indicator moiety comprises at least one enhanced transient time colorimetric indicator.

In a further embodiment, the aforementioned enhanced transient time colorimetric indicator includes an indicator moiety responsive to a singular reactant compound, element or constituent.

In a further embodiment, the aforementioned enhanced transient time colorimetric indicator includes an indicator moiety responsive to plural gaseous compounds, elements and/or constituents.

In a further embodiment, the aforementioned enhanced transient time colorimetric indicator includes an indicator moiety which provides a rate of response to the increased presence of trigger reactant, elements and/or constituents of less than 0.35 sec.

In a further embodiment, the aforementioned enhanced transient time colorimetric indicator includes an indicator moiety which provides a rate of response to diminished presence of trigger reactant, elements and/or constituents after meeting an initial trigger condition of more than 0.50 sec.

In a further embodiment, the aforementioned enhanced transient time colorimetric indicator is used in conjunction with one or more reference or control indicia.

In a further embodiment, the aforementioned enhanced transient time colorimetric indicator comprises one or more reagent chemistries, wherein the reagent chemistries are positioned in different regions of a viewable area.

In a further embodiment, the aforementioned enhanced transient time colorimetric indicator comprises one or more reagent chemistries, wherein the reagent chemistries react to differing gaseous compounds, elements and/or constituents.

In a further embodiment, the aforementioned enhanced transient time colorimetric indicator is used to detect at least one flammable, toxic, carcinogenic or hazardous gaseous compound, element and/or constituent.

In a further embodiment, the aforementioned enhanced transient time colorimetric indicator is used to detect carbon dioxide, and in a particularly preferred embodiment, to detect end tidal carbon dioxide concentration in an expiratory gas.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The invention will be more easily understood by a detailed explanation of the invention including drawings. Accordingly, drawings which are particularly suited for explaining the inventions are attached herewith; however, it should be understood that such drawings are for descriptive purposes only and as thus are not necessarily to scale beyond the measurements provided. The drawings are briefly described as follows:

FIG. 1 is a table depicting the performance attributes of a colorimetric indicator in accordance with the present invention.

### DETAILED DESCRIPTION OF THE INVENTION

While the present invention is susceptible of embodiment in various forms, there is herein described a presently preferred embodiment of the invention, with the understanding that the present disclosure is to be considered as an exemplification of the invention, and is not intended to limit the invention to the specific embodiment described.

In basic operation, a fluid such as a gas sample is conveyed through a fluidic intake path whereupon the gas sample is at least in part redirected to an indicator target. Upon exposure of the indicator target to the gas sample, if the gas sample contains a target species for which the indicator target includes an indication moiety reactant to said target species, the indicator target will present a response. The response of indicator target is presented to the exterior of indicator housing by way of an indicator window.

The indicator target used in the present invention comprises an indicator chemistry and a support substrate. So as to achieve an enhanced transient time colorimetric response in the indicator target, the indicator chemistry utilizes a chemical reaction comprising an indicator, a compatibilizer and optionally a catalyst. The indicator used in the chemical reaction should be responsive to the reactant species, either directly or indirectly, and provide a useful change in properties such that a determination that a change, has indeed, been made due the presence of at least one reactant species can be readily made. Particularly preferred indicators for a colorimetric response includes those having a visually perceptible response, such as due to change in pH, wherein one or more color shifts are made. In the alternative, the indicator may change in reflectance or transmittance of one or more wavelengths which are within the visual color spectrum, outside the visual color spectrum, or a combination thereof. A compatibilizer is employed to more effectively disperse and retain the indicator and optionally the catalyst onto and within the support substrate. Particular compatibilizers to use in an effective enhanced transient time colorimetric response are selected based on the nature of the catalyst, the reactant species migrated by the catalyst, and the support substrate. For the purposes of the present invention, compatibilizers includes those compounds selected from nonionic, cationic and anionic surfactants as well as compounds having surfactant like properties such as chaotropes. In the event a catalyst is used, the catalyst is preferably selected from those chemical compositions in which a phase transfer catalysis occurs by migration of a reactant species. A catalyst of the phase transfer type is particularly beneficial in that it allows for solubilization during indicator chemistry fabrication and, importantly, uniform presentation in a subsequently treated support substrate. Suitable phase transfer catalysts include, but are not limited to, those having a quaternary ammonium or crown ether structure. Further, the compatibilizer may itself have catalytic properties, such as is exemplified by quaternary ammonium surfactants.

It should be noted that the above referenced indicator may respond by a number of different routes to a reactant of interest in triggering the colorimetric indicator. The reactant of interest may interact directly with the indicator, thus causing the indicator to provide a measurable response. In an alternative mechanism, the reactant of interest may interact with the aforementioned optional catalyst to form an intermediate species, wherein the intermediate species then interacts directly with the indicator, thus causing the indicator to provide a measurable response. As a third alternative mechanism, the reactant of interest may interact with second chemistry to form an alternate species, wherein the alternate species then interacts directly with the indicator, thus causing the indicator to provide a measurable response. It is within the purview of the present invention that a combination of one or more direct, intermediate, and alternate species can be used to form a response cascade to trigger one or more corresponding indicators.

Support substrate selection is important for enhanced transient time colorimetric indicator response as amongst other variables, the nominal material must have favorable reactivity to the compatibilized indicator chemistry, a sufficient transfer flow rate and a useful surface area for colorimetric indication. Favorable reactivity of the support substrate to the compatibilized indicator allows for retained placement of the indicator chemistry during fabrication, thus preventing sloughing or other loss of homogenous presentation within the substrate over time. Transfer flow rate is defined by the mean pore size within the substrate and useful surface area is that area of the substrate which is perceptible in a given visual window. Without being constrained to particular modality of operation, the inventor hypothesizes that the coinciding of transfer flow rate and useful surface area with compatibilized indicator chemistry is necessary in attaining an enhanced time transient colorimetric indicator by a mechanism of in-rush and momentary stagnation of a reactant trigger volume. The support substrate containing compatibilized indicator chemistry should allow for a high in-rush acceptance of reactant, thus allowing for reactant interaction with the indicator chemistry and rapid generation of a useful response. After exposure of the reactant and initial response of the indicator chemistry, the indicator chemistry remains generating a useful response through momentary stagnation of the reactant trigger volume within the chosen support substrate until such time that the reactant volume may be consumed and/or is cleared by replacement of a subsequent volume. Thus, a support substrate of an insufficient porous nature will not exhibit momentary stagnation and have a clearance or recovery rate equivalent to the response rate. Conversely, a support substrate of excessive porosity will negatively effect rate of response by consuming a larger fraction of indicator chemistry in non-visible intricacies within the substrate and longer transfer times through the substrate.

### EXAMPLE

Multiple devices were constructed in accordance with the teachings of this disclosure, wherein the indicator target either is a control sample produced in accordance with the teachings of the aforementioned Ratner '971 patent (“Control”), a sample in accordance with the present invention at 0.5 mM Thymol Blue indicator chemistry equivalent to Ratner '971(“Sample A”) or a sample in accordance with the present invention at 2.7 mM Thymol Blue indicator chemistry (“Sample B”). The sample chemistries further included Triton X-15 as a compatibilizer to maintain equivalency to the Control chemistry, and Aliquat 336 (Sigma Chemical P#205613 B#43298LJ) was used as a preferred catalyst. It has been identified in subsequent testing that compatibilizers include, but are not limited to, Sorbitan Monostearate and Tetrakis (2-Hydroxyethyl) Ethylene Diamine. The support substrate was an UltraBind unsupported activated aldehyde affinity membrane having a pore size of 4.5 micron and a nominal thickness of 4.5 to 7.0 mils as available from Pall Filtration.

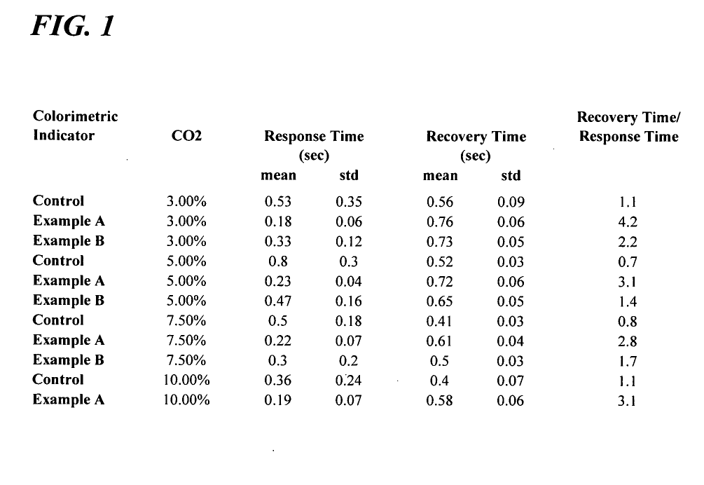

FIG. 1 depicts a controlled carbon dioxide exposure into exemplary device as compared to using an enhanced transient time colorimetric indicator at 0.5 mM or 2.7 mM Thymol Blue. As can be seen in the data present, a conventional colorimetric indicator (Control) provides a response time within the range of about +10% to −30% of recovery time. In comparison, the enhanced transient time of the present invention is evident in the response to recovery time being at least twice the ratio of the control. Further, the enhanced response time of the present invention is also evident in the fact that the colorimetric indicator responds 60% faster than control. It should be noted that the enhanced transient time colorimetric indicator provides a response/recovery profile that has the same total time duration of conventional chemistry, thus for any square wave input of carbon dioxide gas of finite duration, the present invention will display the indicated color for a longer period of time thus improving detection and determination by the clinician while providing equivalent or better sensitivity.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. An enhanced time transient colorimetric indicator comprising;
a. an indicator chemistry;
b. a compatibilizer;
c. a support substrate;
wherein said indicator chemistry provides a measurable response to a target reactant of interest;
wherein said compatibilizer allows for enhanced uptake of the indicator chemistry onto and within said support substrate; and
wherein said enhanced time transient colorimetric indicator exhibits a response time in the presence of target reactant which is less than the recovery time when the said target reactant is subsequently removed.

2. A colorimetric indicator as in claim 1, wherein said indicator chemistry provides a measurable response that is in a visual color range.

3. A colorimetric indicator as in claim 1, wherein said compatibilizer is a surfactant.

4. A colorimetric indicator as in claim 1, wherein said compatibilizer is a chaotrope.

5. A colorimetric indicator as in claim 1, wherein said measurable response is due to a direct reaction with said indictor chemistry.

6. A colorimetric indicator as in claim 1, wherein said measurable response is due to an indirect reaction with said indictor chemistry.

7. A colorimetric indicator as in claim 1, wherein said measurable response is due to an alternate reaction with said indictor chemistry.

8. A colorimetric indicator as in claim 1, wherein said support substrate is porous.

9. A colorimetric indicator as in claim 1, wherein said colorimetric indicator further comprises a catalyst.

10. A colorimetric indicator as in claim 9, wherein said catalyst is a phase transfer catalyst.

11. A colorimetric indicator as in claim 10, wherein said phase transfer catalyst comprises a quaternary amine.

12. A colorimetric indicator as in claim 10, wherein said phase transfer catalyst comprises a crown ether.

13. A colorimetric indicator as in claim 1, wherein said compatibilizer has catalytic properties.

14. A colorimetric indicator as in claim 13, wherein said compatibilizer is a quaternary amine surfactant.

15. A method of visually indicating the presence of a minimum concentration of a gaseous constituent comprising:
a. providing a color changing reactive chemistry
b. providing a porous substrate
c. applying said color changing reactive chemistry to said substrate
d. allowing said coated substrate to dry
e. placing said coated substrate in an unknown gaseous medium for said visual indication of minimum detection of gaseous constituent
